(19) United States
(12) Patent Application Publication
(10) Pub. No.: US 2006/0020507 A1
(43) Pub. Date: Jan. 26, 2006

(54) Method and apparatus for managing multi-entity customer relations

(76) Inventor: Richard W. Sagey, Laguna Niguel, CA (US)

Correspondence Address: Jack J'maev;Suite H, 187 W. Orangethorpe Ave., Placentia, CA, 92870, US

(21) Appl. No.: 10/896,328

(22) Filed: Jul. 21, 2004

(51) Int. Cl. G06Q 30/00

(52) U.S. Cl. 705/14

(57) ABSTRACT

Disclosed are a method and apparatus for managing customer relations programs amongst a plurality of entities. A first customer relations program is managed according to a customer identifier and a first entity identifier. A second customer relations program is managed according to the customer identifier and a second entity identifier.

### BACKGROUND

Among the most effective methods developed by merchants to promote customer loyalty is the “preferred customer card”. An identification card is typically issued to customers that apply for some form of a reward program. A reward program is typically structured to reward regular customers. Some examples of preferred customer cards include, but are not limited to airline frequent flyer cards, preferred auto rental cards, supermarket cards, book store cards and coffee club cards. Use of this card (or the ID number it contains) when ordering services from the merchant can result in discounts, free merchandise or service, upgrades, or special treatment (e.g. early boarding as a frequent airline passenger). Use of a database compiled from applications submitted by customers that apply for these cards also enables a merchant or service provider to boost business by directly contacting their preferred customers with promotional material.

This method has proven to be quite effective, but a problem that tends to limit more widespread use is the bulk of the identification cards. Consumers may not want to carry their entire card collection at all times, and may not want to sort through a stack of preferred customer cards each time they shop. Imagine a trip to a mall where shopping stops are made at seven stores, a fast-food outlet, a restaurant, and a movie. To take full advantage of the “preferred customer” system, a customer would have to sort through a collection of perhaps 30-50 cards to find each of the 10 cards needed for the outing. The hassle-factor represented by this experience will often cause consumers to reject all preferred customer cards except those with the very highest perceived value.

Another problem with the “preferred customer card” approach is that it is often difficult for a small business to justify the resources necessary to derive optimum benefit from a customer loyalty program. Printed paper cards that may be “punched” or marked with a special stamp are often used for these small businesses, and can seem more of a bother than a bonus to many customers. More importantly, a small business simply cannot compete with the types of incentives offered by larger businesses. Because the incentives offered by a small business are perceived as less valuable than those provided by a customer loyalty program administered by a large business, the small business has no means to entice a customer to “apply” for a card. As a result, information pertaining to a customer cannot be gathered and the small business is unable to create a database of customer information that could otherwise be used in a subsequent promotional campaign.

### SUMMARY

Disclosed are a method and apparatus for managing customer relations programs amongst a plurality of entities. A first customer relations program is managed according to a customer identifier and a first entity identifier. A second customer relations program is managed according to the customer identifier and a second entity identifier.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for managing a customer relations program amongst a plurality of entities;

FIG. 2 is a flow diagram that depicts one alternative method for managing a first customer relations program using an aggregate purchase level;

FIG. 3 is a pictorial illustration of one example embodiment of a customer status table;

FIG. 4 is a flow diagram that depicts one alternative method for managing a first customer relations program using a visit tally;

FIG. 5 is a flow diagram that an alternative example method for managing a first customer relations program using a promotional coupon;

FIG. 6 is a flow diagram that depicts yet another alternative method for managing a first customer relations program;

FIG. 7 is a flow diagram that depicts additional steps for managing customer relation programs amongst a plurality of entities;

FIG. 8 is a block diagram that illustrates one example embodiment of a system for managing customer relations amongst a plurality of entities;

FIG. 9 is a data flow diagram that depicts the operation of alternative example embodiments of a customer relations management module;

FIG. 10 is a data flow diagram that depicts the usage of customer information according to one alternative embodiment of a system for managing customer relations amongst a plurality of entities;

FIG. 11 is a flow diagram that depicts one example method for conducting a customer relations transaction;

FIG. 12 is a flow diagram that depicts alternative methods for receiving a transaction customer identifier;

FIG. 13 is a flow diagram that depicts a non-token based method for receiving a transaction customer identifier;

FIG. 14 is a flow diagram that depicts one example method for applying a customer relations program during a transaction;

FIG. 15 is a flow diagram that depicts one example variation of the present method for applying a customer incentive according to an aggregate purchase tally;

FIG. 16 is a flow diagram that depicts one example variation of the present method for applying a customer incentive according to an aggregate visit tally;

FIG. 17 is a flow diagram that depicts one example variation of the present method for applying a customer incentive using a coupon;

FIG. 18 is a flow diagram that depicts one alternative method wherein a new customer identifier is recognized;

FIG. 19 is a block diagram of one example embodiment of a multi-entity aware customer transaction terminal;

FIG. 20 is a composite of several data flow diagrams that depict alternative embodiments of a transaction customer identification unit; and

FIG. 21 is a data flow diagram that depicts the operation of one example embodiment of a transaction terminal.

### DETAILED DESCRIPTION

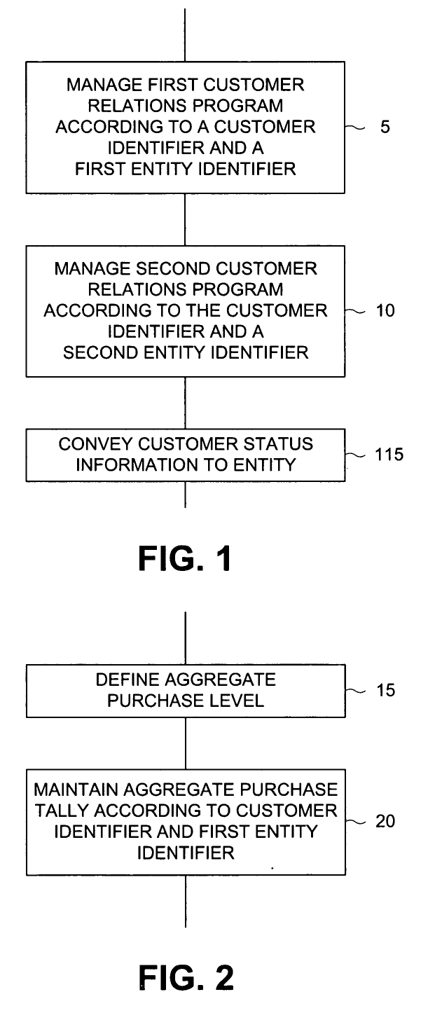

FIG. 1 is a flow diagram that depicts one example method for managing a customer relations program amongst a plurality of entities. According to this example method, a customer relations program is managed amongst a plurality of entities by managing a first customer relations program according to a customer identifier and a first entity identifier (step 5). A second customer relations program is managed according to the same customer identifier and a second entity identifier (step 10).

FIG. 2 is a flow diagram that depicts one alternative method for managing a first customer relations program using an aggregate purchase level. According to one illustrative alternative method, a first customer relations program is managed by defining an aggregate purchase level for an incentive (step 15). For example, a first entity may establish a minimum purchase level that a customer must achieve before an incentive is provided. Accordingly, a minimum aggregate purchase level is, according to this variation of the present method, associated with a first entity identifier. According to this variation of the present method, management of a first customer relations program is administered by maintaining an aggregate purchase tally that is associated with a customer identifier and a first entity identifier (step 20). Typically, an incentive is provided to a customer when the aggregate purchase tally associated with the customer's identifier for a particular entity identifier has reached the defined minimum purchase level associated with that particular entity's entity identifier. It should be noted that, according to one variation of the present method, a second customer relations program is managed according to the same customer identifier. As such, a different aggregate purchase tally is associated with the same customer identifier and is further associated with a second entity identifier. As a consequence, a particular customer identifier, according to one illustrative use case, will have two or more different purchase tallies wherein each purchase tally is associated with the same customer identifier but is further associated with a different entity identifier.

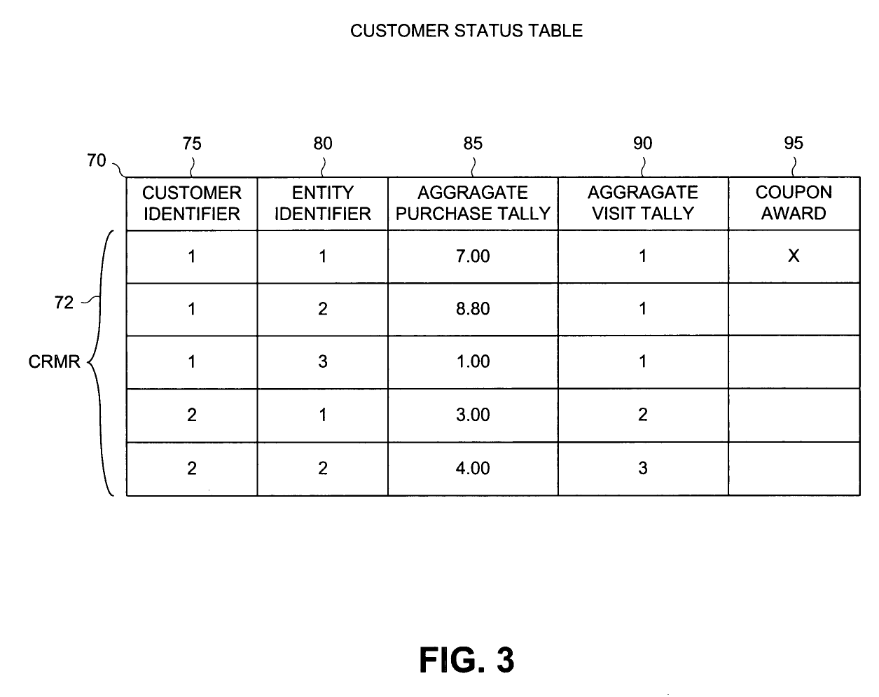

FIG. 3 is a pictorial illustration of one example embodiment of a customer status table. According to one illustrative variation of the present method, an aggregate purchase level (i.e. a tally) for a first customer identifier associated with a first entity identifier is stored in a customer status table 70. According to one alternative variation of the present method, the customer status table 70 is used to store one or more customer relations management records (CRMR) 72 wherein each customer relations management record includes a customer identifier field 75 and entity identifier field 80. According to yet another alternative variation of the present method, the customer status table 70 further includes an aggregate purchase tally field 85. Accordingly, when a customer makes a purchase at a first entity (e.g. a bagel shop), the customer status table 70 is updated by selecting a record according to a customer identifier and an entity identifier stored in a corresponding customer identifier field 75 and entity identifier field 80. The selected record is typically updated according to information received from a transaction terminal located at the first entity. Such a transaction terminal further typically provides a purchase amount which is then aggregated to any current value stored in the aggregate purchase tally field 85 of the selected record. It should be noted that a first entity can include any merchant or service provider desirous of administering a customer relations program according to the techniques and teachings presented herein. The values of customer identifiers, entity identifiers and any aggregate purchase tally depicted in the figure are presented for the purposes of illustrating the present method and are not intended to limit the scope of the claims appended hereto.

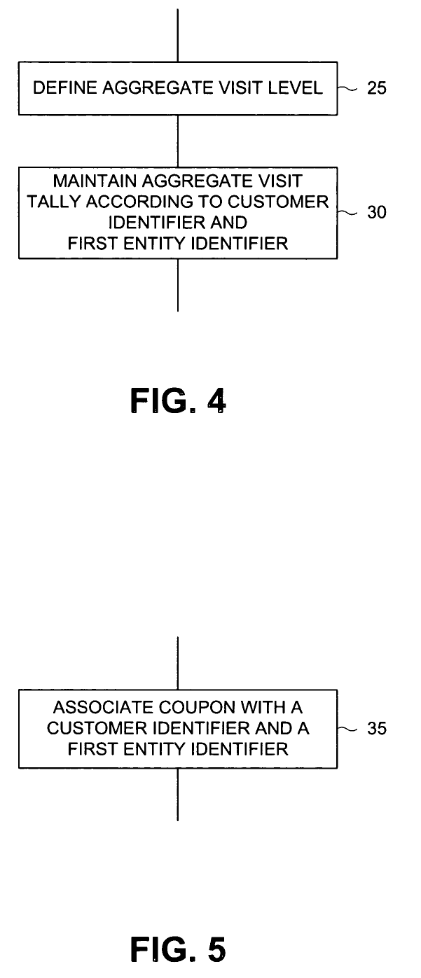

FIG. 4 is a flow diagram that depicts one alternative method for managing a first customer relations program using a visit tally. According to this alternative method, a customer relations program is managed by defining an aggregate visit level for an incentive (step 25). For example, a first entity may establish a minimum visit level that a customer must achieve before an incentive is provided. Accordingly, a minimum aggregate visit level is, according to this variation of the present method, associated with a first entity identifier. According to this variation of the present method, management of a first customer relations program is administered by maintaining an aggregate visit tally that is associated with a customer identifier and a first entity identifier (step 30). Typically, an incentive is provided to a customer when the aggregate visit tally associated with the customer's identifier for a particular entity identifier has reached the defined minimum visit level associated with that particular entity's entity identifier. It should be noted that, according to one variation of the present method, a second customer relations program is managed according to the same customer identifier. As such, a different aggregate visit tally is associated with the same customer identifier and is further associated with a second entity identifier. As a consequence, a particular customer identifier, according to one illustrative use case, will have two or more different visit tallies wherein each visit tally is associated with the same customer identifier but is further associated with a different entity identifier.

FIG. 3 further depicts one alternative embodiment of a customer status table 70 that is used by this alternative variation of the present method wherein a customer relations management record 72 is selected according to a customer identifier and an entity identifier stored in a corresponding customer identifier field 75 and entity identifier field 80. Such record is updated by incrementing a present value stored in an aggregate visit tally field 90 included in this alternative embodiment of a customer status table 70. Again, it should be noted that any values of an aggregate visit tally depicted in the figure are presented for the purposes of illustration only and are not intended to limit the scope of the claims appended hereto.

FIG. 5 is a flow diagram that an alternative example method for managing a first customer relations program using a promotional coupon. According to this alternative method, a first customer relations program is managed by associating a coupon with a customer identifier and a first entity identifier. For example, an entity may award a coupon to a particular customer having a corresponding customer identifier.

FIG. 3 further depicts yet another alternative embodiment of the customer status table 70 useful for associating a coupon with a particular customer identifier and a particular entity identifier. According to this alternative embodiment, the customer status table 70 further comprises a coupon award field 95. According to one illustrative use case, the present method is applied by setting an indicator in the coupon award field 95 included in a customer relations management record 72 selected according to a customer identifier and an entity identifier stored in a corresponding customer identifier field 75 and an entity identifier field 80. Accordingly, an incentive is provided to a customer when a coupon is so indicated in the coupon award field 95 in a selected customer relations management record 72.

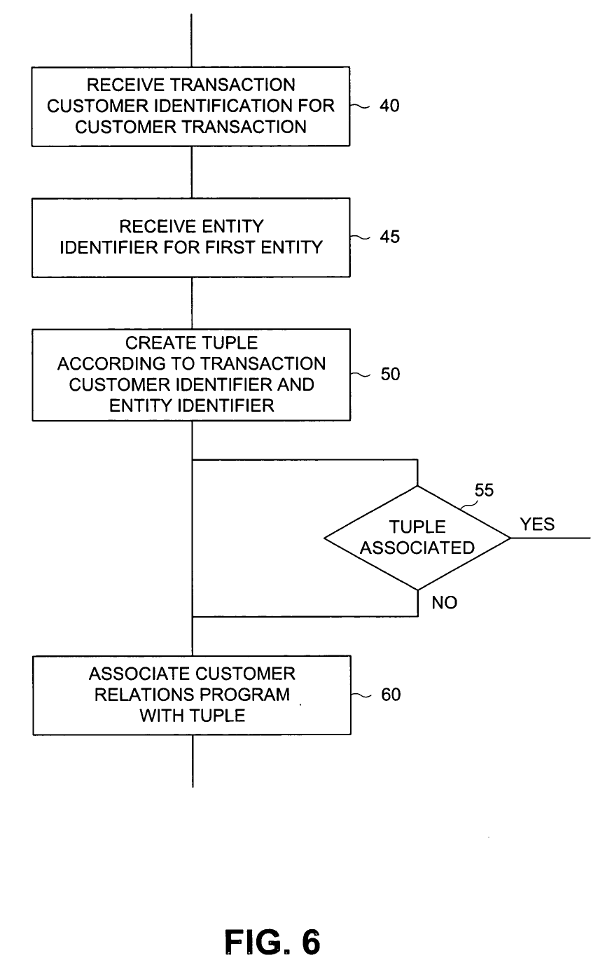

FIG. 6 is a flow diagram that depicts yet another alternative method for managing a first customer relations program. It should now be appreciated that a first customer relations program, according to the present method, is managed according to a customer identifier and a first entity identifier. At some point in time, a customer identifier is first recognized and associated with a particular first entity identifier. One variation of the present method relies on randomly distributed tokens that include a customer identifier. As the present method is utilized, a customer may present to an entity (e.g. a merchant or service provider) one of these randomly distributed tokens. But if the customer identifier included in the tokens has not yet been recognized, there can be no association of a customer relations program with the previously unrecognized customer identifier. In furtherance of the present method, a transaction customer identifier is received for a customer (step 40) as a result of a transaction. Typically, the transaction customer identifier corresponds to a customer identifier included in a randomly distributed token. The entity that processes the transaction, according to this variation of the present method, is identified by an entity identifier (i.e. a first entity identifier). As such, the entity identifier is received (step 45) and is used in conjunction with the transaction customer identifier to create a tuple (step 50). In the event that the tuple is not yet associated (step 55) with a customer relations program, the newly created tuple is associated with a customer relations program (step 60). The customer relations program associated with the newly created tuple can include, but is not necessarily limited to an aggregate purchase level program, an aggregate visit level program and a coupon as heretofore described.

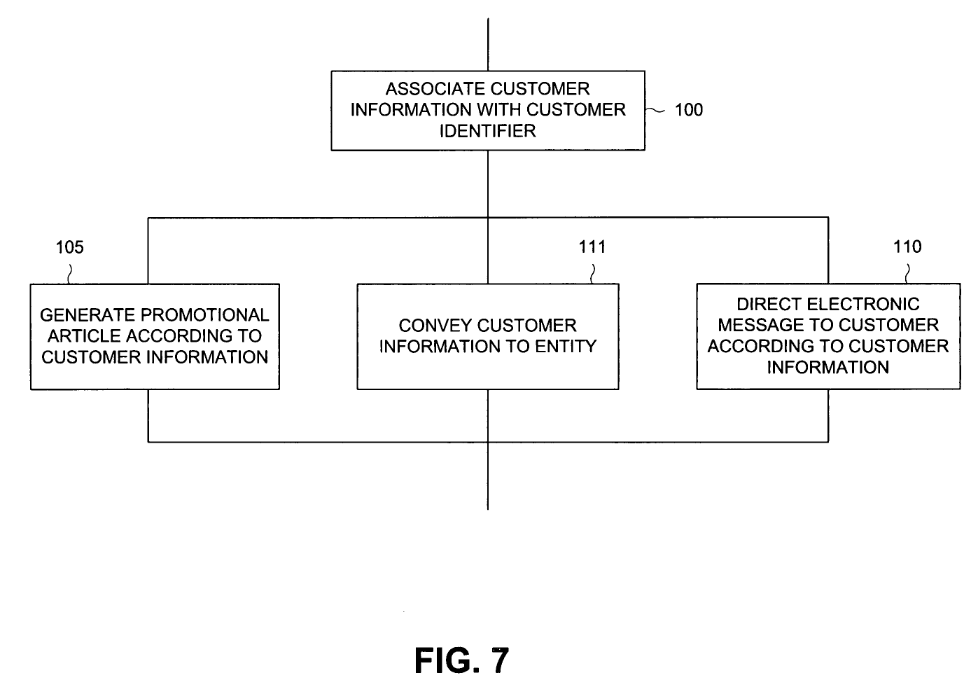

FIG. 7 is a flow diagram that depicts additional steps for managing customer relation programs amongst a plurality of entities. According to one variation of the present method, customer information is associated with a customer identifier (step 100) once the customer identifier is recognized. For example, as already described, a customer identifier may first be recognized as the result of a transaction processed by an entity. Customer information can then be gathered and associated with the customer identifier. According to one illustrative variation of the present method, customer information includes, but is not necessarily limited to a first name, a last name, an address, a city, a state, a zip code, a phone number, a cell phone number, an electronic mail (e-mail) address and a birth-date.

Once customer information is gathered and associated with the customer identifier, one variation of the present method provides for generating a promotional article according to the associated customer information (step 105). A promotional article includes, but is not limited to a mailer. According to another variation of the present method, the promotional article is directed to a customer by consulting associated customer information in order to obtain name, address, city, state and zip code enabling conventional mail delivery of the promotional information to the customer. According to yet another variation of the present method, an electronic message is directed to a customer according to the associated customer information (step 110). For example, according to yet another illustrative variation of the present method, a promotional message is directed to the customer using an e-mail address included in information associated with the customer's customer identifier. According to yet another illustrative variation of the present method, an electronic message is directed to a cellular telephone as an SMS message (SMS stands for “short message service”, a service widely available on cellular telephones). According to this illustrative variation of the present method, the SMS message is directed to a cellular telephone using a cellular telephone number included in information associated with the customer's customer identifier. According to yet another illustrative derivative method, an electronic message includes a promotional message directed to a customer.

According to one illustrative variation of the present method, customer information is conveyed to an entity (step 111). The type of information conveyed to an entity can include but is not necessarily limited to a first name, a last name, an address, a city, a state, a zip code, a phone number, a cell phone number, an electronic mail (e-mail) address and a birth-date. The customer identifier associated with this customer information is also typically conveyed to the entity. This customer information can be stored in a transaction terminal located at the entity's facility and can be used at a later time to identify a customer when a customer identifier cannot otherwise be used to identify the customer.

FIG. 1 further illustrates that one example variation of the present method provides for conveying customer status information to an entity. As information is gathered according to the present method, it may need to be disseminated from a first location to a second location. For example, status pertaining to a particular customer (e.g. an aggregate purchase tally, an aggregate visit tally and coupon availability) may be required locally by an entity applying the present method. In this case, one derivative variation of the present method provides for conveying status information to the entity (step 115). This particular derivative variation of the present method is aptly applied for a point-of-sale terminal that supports management of customer relations. In order to provide rapid recognition of a customer and determination of a potential for incentive, all information associated with the particular entity identifier is conveyed to the entity in batch form. In one alternative variation of the present method, the customer status information is conveyed to an entity on a demand basis. For example, when an entity begins a customer transaction, the entity requests status information for the customer once the customer's customer identifier has been determined. Although this method will exhibit greater latency when compared to the batch mode of conveying a larger block of customer information to an entity, this variation of the present method may be more suitable where a transaction terminal located at an entity's facility has limited capability for storing a large block of customer status information or in the case where real-time customer status information is required or desired.

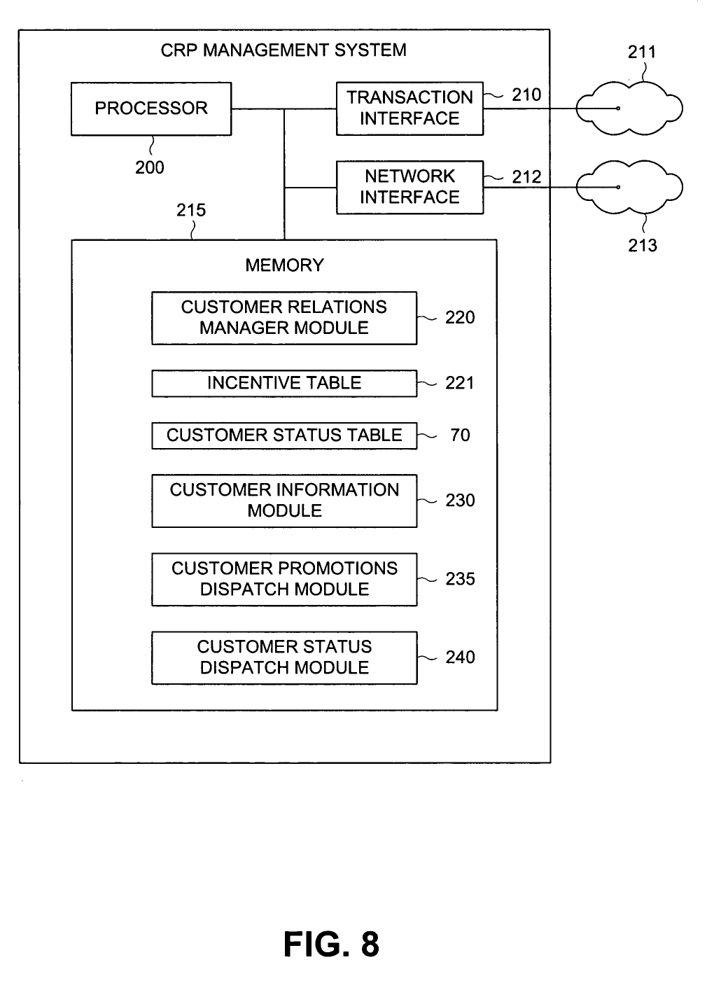

FIG. 8 is a block diagram that illustrates one example embodiment of a system for managing customer relations amongst a plurality of entities. According to this example embodiment, a system 205 for managing customer relations amongst a plurality of entities comprises one or more processors 200, a transaction interface 210, a memory 215 and one or more functional modules. According to one alternative embodiment, the system 205 further comprises a network interface 212. A functional module, according to one alternative embodiment, is embodied as an instruction sequence stored in the memory 215. The reader is advised that the term “minimally causes the processor” and variants thereof is intended to serve as an open-ended enumeration of functions performed by the processor 200 as it executes a particular functional module (i.e. instruction sequence). As such, an embodiment where a particular functional module causes a processor to perform functions in addition to those defined in the appended claims is to be included in the scope of the claims appended hereto. It should also be noted that, according to one alternative embodiment, a portion of the memory 215 is used for storage of an incentive table 221. In yet another alternative embodiment, a portion of the memory 215 is used for storage of a customer status table 70.

According to this example embodiment, the system 205 further includes a customer relations management module 220. According to this example embodiment, the customer relations management module 220, when executed by the processor 200, minimally causes the processor 200 to manage a first customer relations program according to a customer identifier and a first entity identifier. The customer relations management module 220 further minimally causes the processor 200 to manage a second customer relations program according to the customer identifier and further according to a second entity identifier. According to yet another alternative embodiment, the system 205 further includes in the memory 215 a customer information module 230. According to yet another alternative embodiment, the system 205 further includes in the memory 215 a customer promotions dispatch module 235. In yet another alternative embodiment, the system 205 further includes in the memory 215 a customer status dispatch module 240.

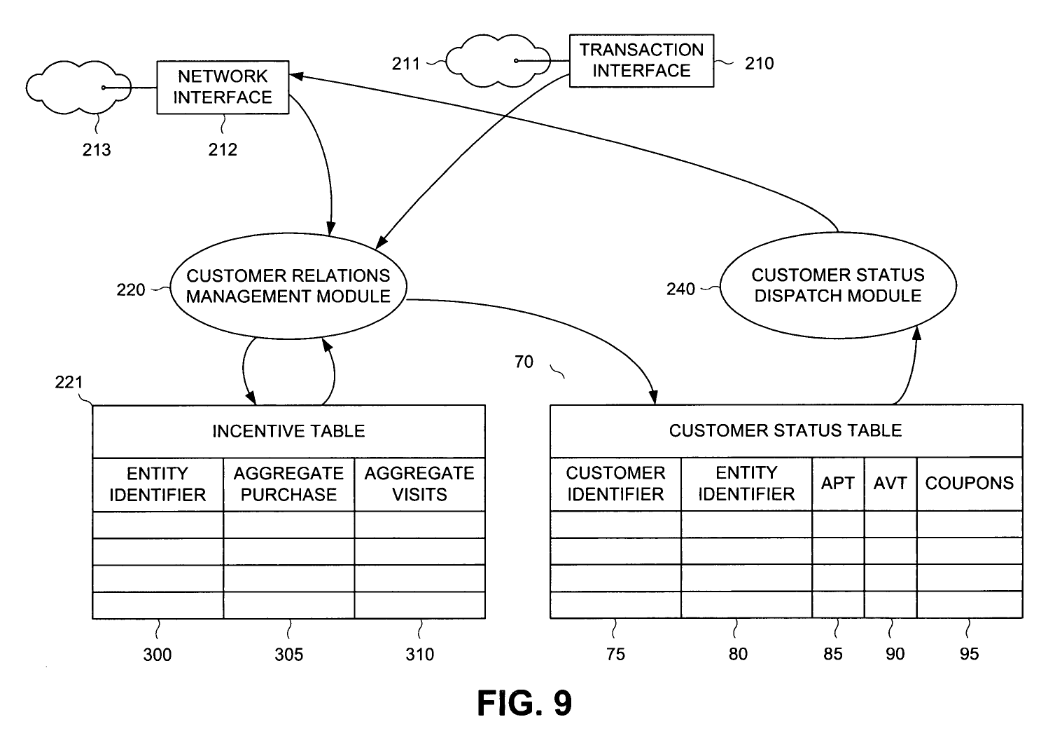

FIG. 9 is a data flow diagram that depicts the operation of alternative example embodiments of a customer relations management module. According to one alternative embodiment, the customer relations management module 220, when executed by the processor 200, minimally causes the processor to accept an aggregate purchase level for incentive. The aggregate purchase level for incentive, according to one example embodiment, is received from a network 213 by way of a network interface 212. According to one example embodiment, the aggregate purchase level for incentive is received together with an entity identifier. This aggregate purchase level for incentive is then associated with the entity identifier. According to one alternative embodiment, the customer relations management module 220 minimally causes the processor to store the minimum data purchase level for incentive and the associated entity identifier in an incentive table 221 stored in the memory 215. According to one illustrative embodiment, the incentive table 221 includes one or more records wherein each such record includes a field for an entity identifier 300. The incentive table 221 of this illustrative embodiment further includes a field for an aggregate purchase level 305. It should be noted that the aggregate purchase level for incentive for any particular entity can be determined by using the entity identifier field 300 as an index for looking up a value for a minimum aggregate purchase level associated with a particular entity identifier.

According to one alternative embodiment, the customer relations module 220, when executed by the processor 200, further minimally causes the processor 200 to convey at least one of an aggregate purchase level and an aggregate visit level associated with an entity to the network interface 212. A transaction terminal located at an entity's facility can then receive either of the aggregate purchase level and the aggregate visit level.

According to this alternative embodiment, the customer relations management module 220 further minimally causes the processor 200 to receive a transaction message from a transaction network 211 by means of a transaction interface 210. According to this alternative embodiment, the customer relations management module 220 causes the processor 200 to receive a transaction message that includes a first entity identifier, a customer identifier and a purchase amount. As such, the customer relations management module 220 further minimally causes the processor 200 to maintain an aggregate purchase tally (APT) according to the first entity identifier, the customer identifier and the purchase amount, each of which are included in the transaction message. According to one alternative embodiment, the customer relations management module 220 causes the processor 200 to store this information in the customer status table 70 stored in the memory 215. As such, the customer identifier and the entity identifier included in the transaction message are used to select a record stored in the customer status table 70 and a value stored in an aggregate purchase tally field 85 in the selected record is updated according to the purchase amount included in the transaction message received by the processor 200 as it executes this alternative embodiment of a customer relations management module 220.

According to yet another alternative embodiment, the customer relations management module 220 minimally causes the processor 200 to accept an aggregate visit level for incentive. According to this alternative embodiment, the aggregate visit level for incentive is received by way of the network interface 212 from a data network 213. The customer relations management module 220 of this alternative embodiment further minimally causes the processor 200 to receive an entity identifier along with the minimum aggregate visit level for incentive. The processor 200 is further minimally caused to store the aggregate visit level for incentive and the entity identifier in the incentive table 221. According to this alternative embodiment, each record stored in the incentive table 221 further includes an aggregate visit level field 310. It should be noted that the aggregate visit level for incentive for any particular entity can be determined by using the entity identifier field 300 as an index for looking up a value for a minimum aggregate visit level associated with a particular entity identifier.

According to this alternative embodiment, the customer relations management module 220 further minimally causes the processor 200 to receive a transaction message from a transaction network 211 by means of a transaction interface 210. According to this alternative embodiment, the customer relations management module 220 causes the processor 200 to receive a transaction message that includes a first entity identifier and a customer identifier. As such, the customer relations management module 220 further minimally causes the processor 200 to maintain an aggregate visit tally (AVT) according to the first entity identifier and the customer identifier, each of which are included in the transaction message. According to one alternative embodiment, the customer relations management module 220 causes the processor 200 to store this information in the customer status table 70 stored in the memory 215. As such, the customer identifier and the entity identifier included in the transaction message are used to select a record stored in the customer status table 70 and a value stored in an aggregate visit tally field 85 in the selected record is incremented by the processor 200 as it executes a customer relations management module 220.

According to yet another alternative embodiment, the customer relations management module 220 causes the processor 200 to manage a first customer relations program by minimally causing the processor 200 to accept a coupon identifier and associate the coupon identifier with the customer identifier and a first entity identifier. Accordingly, this example alternative embodiment of the customer relations management module 220 causes the processor 200 to update a coupon field 95 included in a record stored in the customer status table 70, where the record is selected according to the customer identifier and the first entity identifier.

It should be noted that according to yet another alternative embodiment, the customer relations management module 220 minimally causes the processor 200 to create a tuple according to an entity identifier and a customer identifier that are included in a transaction message received by the processor 200 by way of the transaction interface 210 as it executes this alternative embodiment of the customer relations management module 220. The tuple is created when a record cannot be found in the customer status table 70 that matches the newly created tuple. Put plainly, if a record cannot be found in the customer status table 70 wherein the customer identifier field 75 and the entity identifier field 80 do not match the newly created tuple, the system 205 infers that a particular customer identifier has not yet been associated with a particular entity identifier. As such, a default customer relations program is then associated with a newly created record in the customer status table 70. Accordingly, this alternative embodiment of a customer relations management module 220 further minimally causes the processor to create a new record in the customer status table 70 and store the tuple in the customer identifier field 75 and the entity identifier field 80 included in the new record.

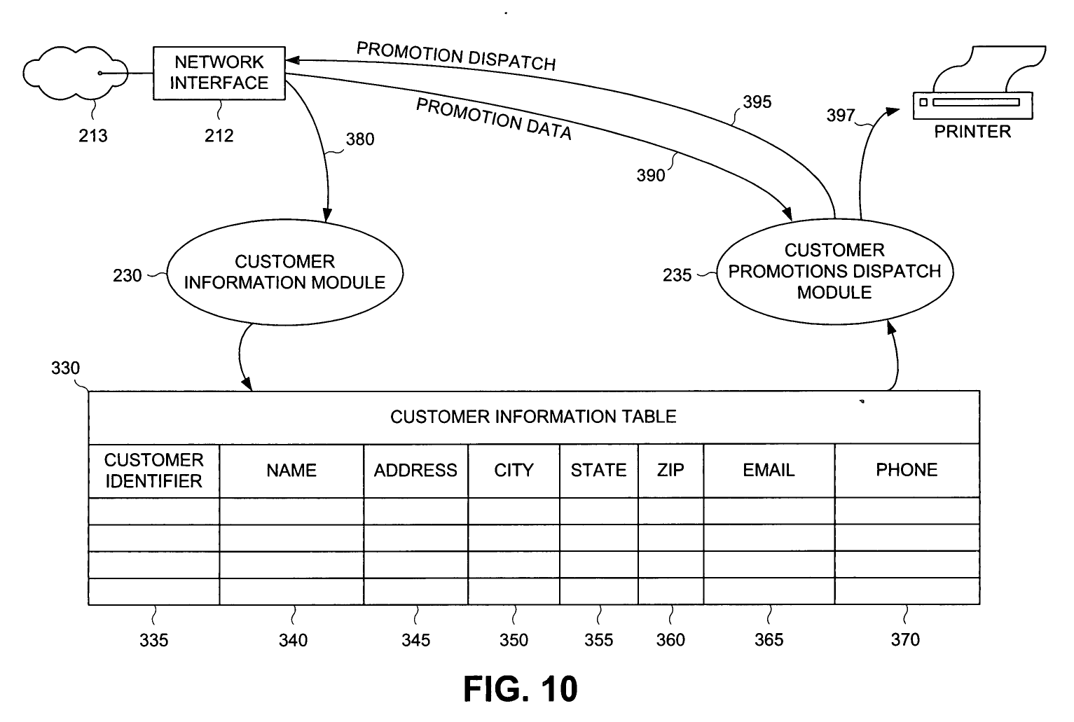

FIG. 10 is a data flow diagram that depicts the usage of customer information according to one alternative embodiment of a system for managing customer relations amongst a plurality of entities. According to this alternative embodiment, a system for managing customer relations amongst a plurality of entities further comprises the network interface 212 that enables communication with a wide area network 213. According to this alternative embodiment, the system 205 further includes a customer information module 230 that, when executed by the processor 200, minimally causes the processor 200 to receive 380 customer information by way of the network interface 212. Once the customer information module 230 minimally causes the processor 200 to receive said customer information, the customer information is stored in a customer information table 330. According to this alternative embodiment, the customer information table 330 is stored in the memory 215. According to this alternative embodiment, the customer information module 230 minimally causes the processor 200 to receive customer information that includes, but is not necessarily limited to a first name, a last name, an address, a city, a state, a zip code, a phone number, a cell phone number, an electronic mail (e-mail) address and a birth-date. Accordingly, one example of the customer information table 330 includes fields for at least one of a customer name and 40, a customer address 345, a customer city 350, a customer state 355, a customer zip code 360, a customer e-mail 365 and a customer cell telephone number 370.

According to yet another alternative embodiment, the system 205 has included in the memory 215 a customer promotions dispatch module 235 that, when executed by the processor 200, minimally causes the processor to receive promotional data 390 by way of the network interface 212. The promotional data 390 includes, but is not limited to a reduced price (i.e. a sale price) for goods and/or services provided by an entity. According to one alternative embodiment of a customer promotions dispatch module 235, the processor 200 is caused to generate a promotional message according to the customer information stored in the customer information table 330. The promotional message includes the promotional data 390 received from the wide area network 213 by way of the network interface 212. The generated promotional message is then conveyed to a print interface 397. The customer promotions dispatch module 235, according to one alternative embodiment, minimally causes the processor 200 to generate a promotional message using the promotional data 390 and using information such as the name and address of a customer included in a record stored in the customer information table 330.

According to yet another alternative embodiment, the customer promotions dispatch module 235 conveys a promotional message to a customer in the form of an electronically deliverable message. According to one alternative embodiment, the customer promotions dispatch module 235 causes the processor to dispatch a promotional message in the form of an electronic mail message. In this case, the processor 200 determines a target electronic mail address retrieving a value from an electronic mail address field 365 included in the customer information table 330. According to yet another alternative example embodiment, the customer promotions dispatch module 235 minimally causes the processor 200 to generate an SMS message deliverable to a particular cell phone number according to the cell phone number stored in the cell phone number of field 370 of a customer record included in the customer information table 330. Accordingly, the promotional message is dispatched 395 to a cell phone system by way of the network interface 212. As such, the cell phone system receives the promotional message by way of the wide area network 213.

FIG. 9 further illustrates that, according to one alternative embodiment, the system 205 further comprises a customer status dispatch module 240. The customer status dispatch module 240 of this alternative embodiment minimally causes the processor 200 to convey to an entity status information for one or more customers included in the customer status table 70. Customer status information is conveyed to the entity by way of the network interface 212 which directs the customer status information to a wide area network 213. According to one alternative embodiment, customer status information that is conveyed to an entity includes, but is not limited to an aggregate purchase tally. According to another alternative embodiment, customer status information that is conveyed to an entity includes, but is not limited to an aggregate visit tally. According to yet another alternative embodiment, customer status information that is conveyed to an entity includes, but is not limited to a coupon definition.

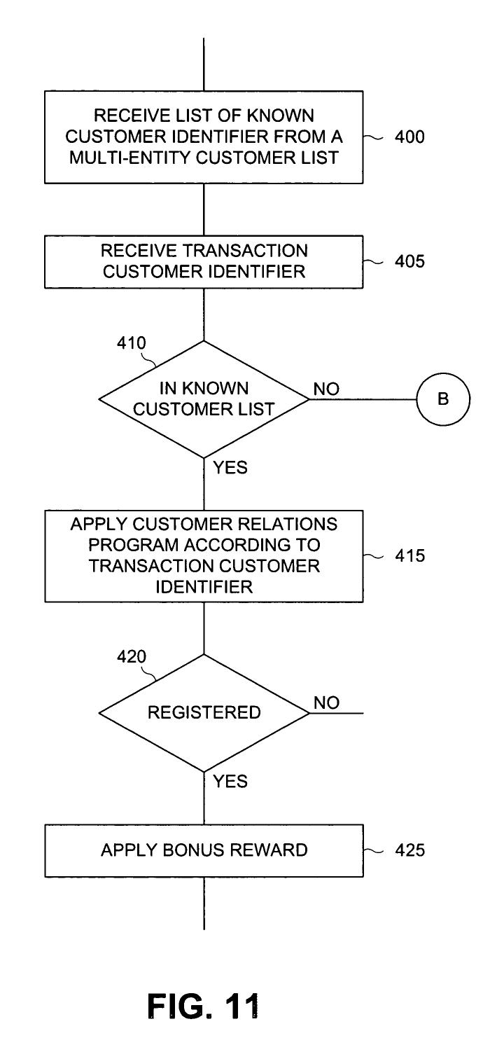

FIG. 11 is a flow diagram that depicts one example method for conducting a customer relations transaction. According to this example method, a customer relations transaction is conducted by receiving a list of known customer identifiers (step 400). Typically, the list of known customer identifiers is received from a multi-entity customer list. Once the list of known customer identifiers is received, a transaction customer identifier is received (step 405). The transaction customer identifier is typically received during a customer transaction and is used to identify a particular customer which is engaging in the transaction. In the case where the customer identifier is found (step 410) in the known customer list, a customer relations program is applied to the transaction according to the transaction customer identifier (step 415). Typically, a customer relations program includes, but is not limited to at least one of an aggregate purchase tally method, an aggregate visit tally method and a coupon identification method.

In order to induce a customer to register their customer information with a system for managing customer relations programs across multiple entities, one variation of the present method provides for determining when a customer has registered with the system (step 420). When the customer identifier corresponds to a registered customer, a bonus incentive award is applied to the transaction (step 425).

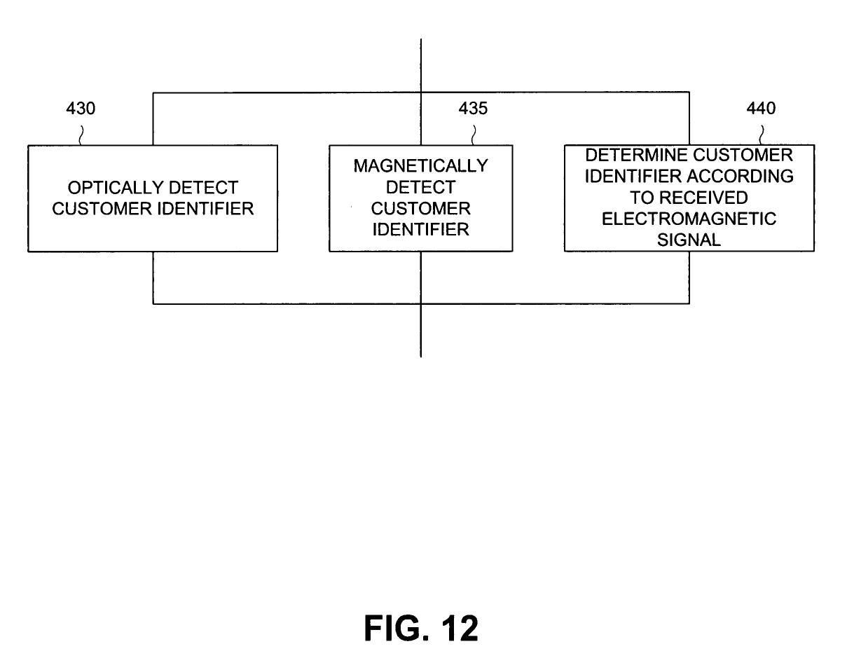

FIG. 12 is a flow diagram that depicts alternative methods for receiving a transaction customer identifier. According to one alternative variation of the present method, a transaction customer identifier is received by optically detecting a customer identifier (step 430). For example, a customer identifier in the form of a bar-code can be optically perceived according to this variation of the present method. According to yet another variation of the present method, a transaction customer identifier is received magnetically (step 435). For example, a customer identifier in the form of a magnetically encoded stripe on a “mag-stripe” of a card can be perceived magnetically. According to yet another alternative variation of the present method, a customer identifier is received by way of an electromagnetic signal (step 440). For example, a customer identifier can be stored in an identification transponder such as a radio frequency identification (RFID) transponder or a SmartChip™. In this situation, an electromagnetic reader can be used to interrogate the radio frequency identification transponder or the SmartChip. It should be noted that various types of radio frequency identification transponders can be used and the scope of the claims appended hereto is not intended to be limited to any examples presented herein.

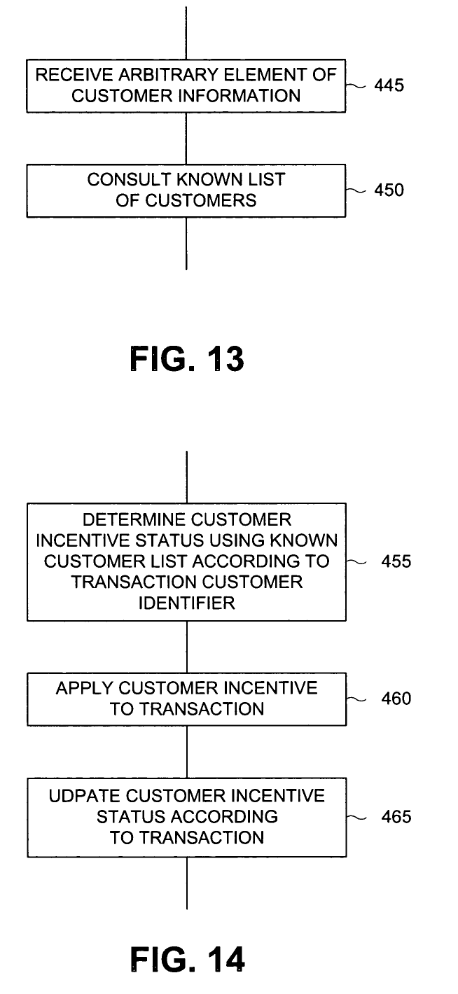

FIG. 13 is a flow diagram that depicts a non-token based method for receiving a transaction customer identifier. According to this alternative method, a transaction customer identifier is actually determined by receiving an arbitrary element of customer information (step 445) and then consulting a list of known customers (step 450). According to one variation of the present method, the list of known customers includes information that can be searched according to the received arbitrary element of customer information. When the arbitrary element of customer information is found in the information included in the known customer list, a corresponding customer identifier is used as the transaction customer identifier for a transaction. For example, a customer's telephone number can be used to find a record in the list of known customers. If the telephone number can be found in the list of known customers, a customer identifier associated with that record is then used as the transaction customer identifier. It should be noted that this example is meant to illustrate and is not intended to limit the scope of the claims appended hereto.

FIG. 14 is a flow diagram that depicts one example method for applying a customer relations program during a transaction. According to this example method, once a transaction customer identifier is received, a list of known customers is consulted in order to determine an incentive status (step 455). An incentive is applied to the transaction according to the determined incentive status (step 460). In yet another alternative variation of the present method, particulars of a customer transaction, e.g. the amount of a purchase, is used to update the customer incentive status (step 465). According to yet another alternative variation of the present method, particulars of the customer transaction are conveyed to a multi-entity customer relations management system. The multi-entity customer relations management system then updates a customer incentive status maintained therein according to the particulars of a customer transaction.

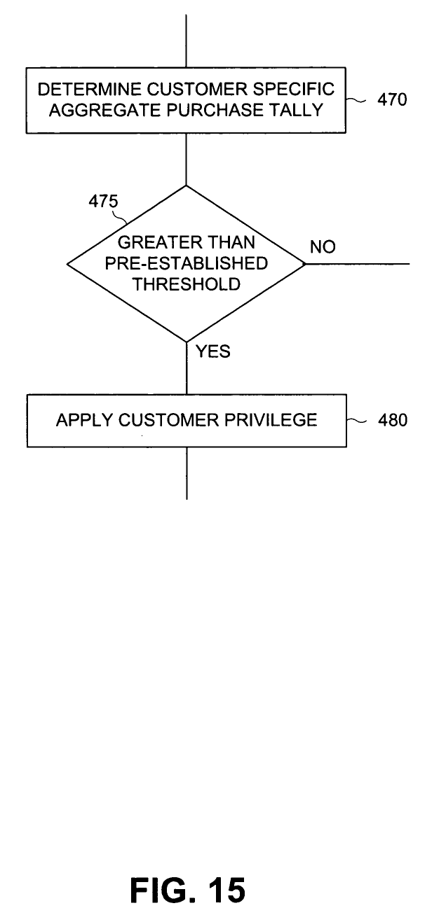

FIG. 15 is a flow diagram that depicts one example variation of the present method for applying a customer incentive according to an aggregate purchase tally. According to this variation of the present method, an aggregate purchase tally for a specific customer is determined (step 470). According to yet another variation of the present method, this is accomplished by consulting a list of known customers according to a transaction customer identifier. Once a record in the known customer list is selected according to the transaction customer identifier, an aggregate purchase tally is retrieved from the record. Accordingly, when the aggregate purchase tally for a particular customer exceeds a pre-established amount (step 475), a customer privilege is applied to the transaction (step 480). The customer privilege, according to yet another variation of the present method, comprises a discount. According to yet another variation of the present method, the customer privilege comprises a free product or service. It should be noted that the sample customer privileges described herein are intended to illustrate the present method and are not intended to limit the scope of the claims appended hereto.

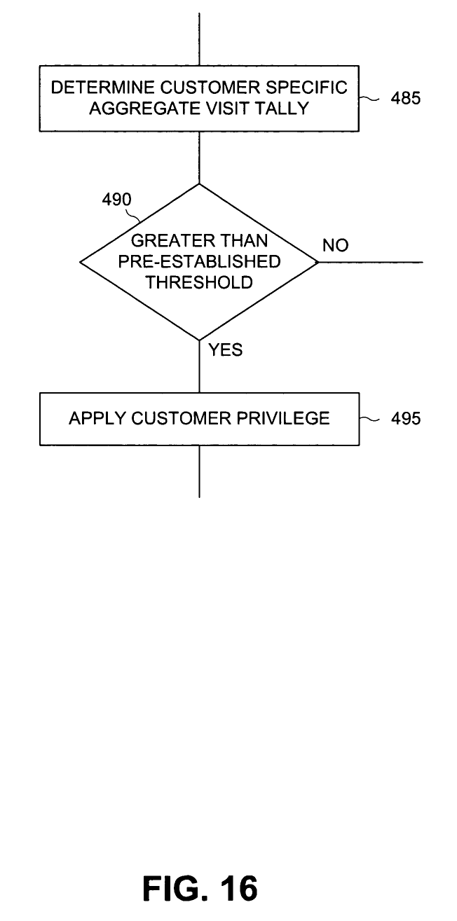

FIG. 16 is a flow diagram that depicts one example variation of the present method for applying a customer incentive according to an aggregate visit tally. According to this variation of the present method, an aggregate visit tally for a specific customer is determined (step 485). According to yet another variation of the present method, this is accomplished by consulting a list of known customers according to a transaction customer identifier. Once a record in the known customer list is selected according to the transaction customer identifier, an aggregate visit tally is retrieved from the record. Accordingly, when the aggregate visit tally for a particular customer exceeds a pre-established amount (step 490), a customer privilege is applied to the transaction (step 495). The customer privilege, according to yet another variation of the present method, comprises a discount. According to yet another variation of the present method, the customer privilege comprises a free product or service. It should be noted that the sample customer privileges described herein are intended to illustrate the present method and are not intended to limit the scope of the claims appended hereto.

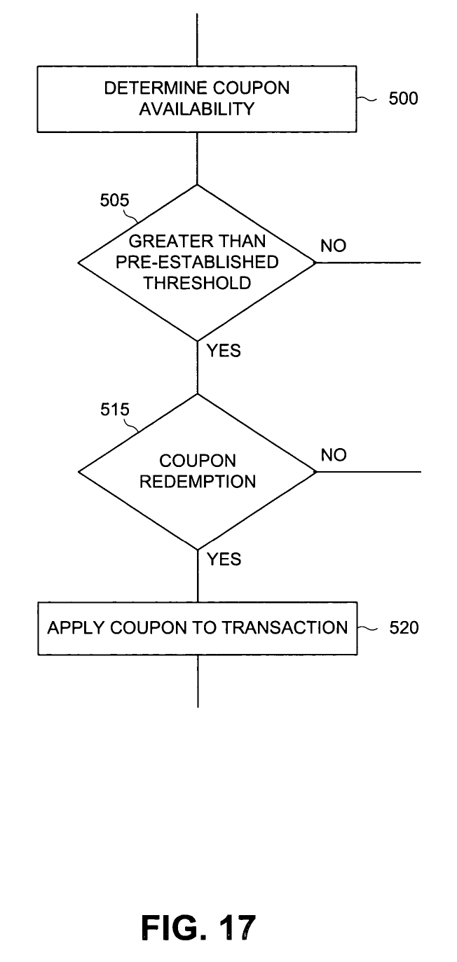

FIG. 17 is a flow diagram that depicts one example variation of the present method for applying a customer incentive using a coupon. According to this variation of the present method, the availability of a coupon for a specific customer is determined (step 500). According to yet another variation of the present method, this is accomplished by consulting a list of known customers according to a transaction customer identifier. Once a record in the known customer list is selected according to the transaction customer identifier, coupon availability information is retrieved from the record. Accordingly, when the coupon availability information for a particular customer indicates that a coupon is available (step 505) and a customer chooses to redeem the coupon (step 515), a customer privilege is applied to the transaction (step 520). It should be noted that the coupon information, according to yet another variation of the present method, is presented to a customer during a transaction. By presenting the coupon information to the customer, the customer can then choose to redeem the coupon. In the case where the customer chooses not to redeem the coupon, a customer privilege is not applied to the pending customer transaction. The customer privilege, according to yet another variation of the present method, comprises a discount. According to yet another variation of the present method, the customer privilege comprises a free product or service. It should be noted that the sample customer privileges described herein are intended to illustrate the present method and are not intended to limit the scope of the claims appended hereto.

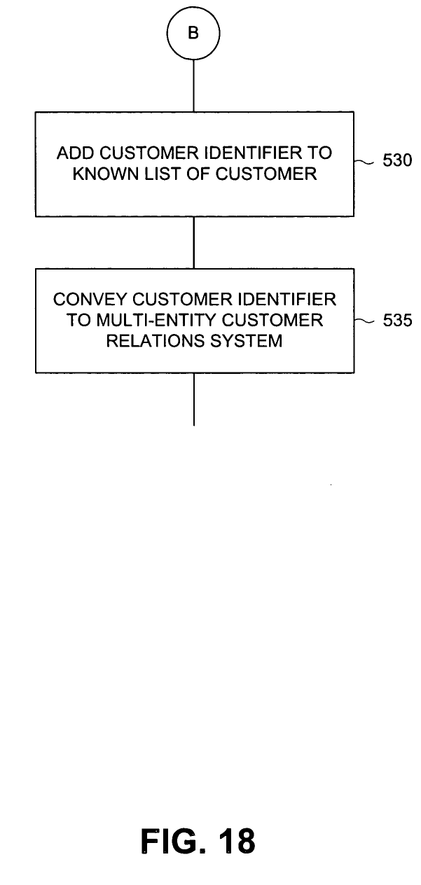

FIG. 18 is a flow diagram that depicts one alternative method wherein a new customer identifier is recognized. According to this alternative illustrative method, when the customer identifier is not found in the list of known customer identifiers (step 410 in FIG. 11), the transaction identifier is added to the list of known customer identifiers as a new customer identifier (step 530). The new customer identifier is then conveyed to a multi-entity customer relations management system (step 535). As such, when a new identifier is recognized by a transaction terminal at a first entity, the transaction identifier is added to a multi-entity database as a new customer identifier. Accordingly, the updated database can be communicated to other entities enrolled with the multi-entity customer relations management system.

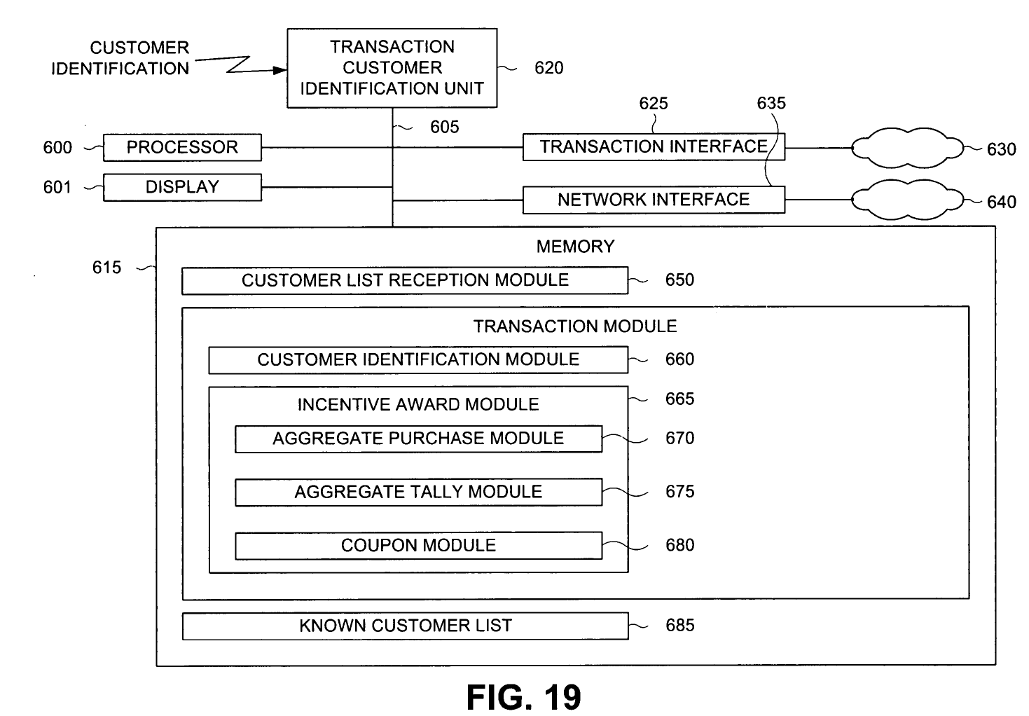

FIG. 19 is a block diagram of one example embodiment of a multi-entity aware customer transaction terminal. According to this illustrative embodiment, a multi-entity aware customer transaction terminal comprises one or more processors 600, a transaction interface 625 and a network interface 635. The transaction interface 625 is capable of communicating with a transaction network 630. The network interface is capable of communicating with a wide area network 640.

According to this example embodiment, transaction terminal also includes a memory 615 and one or more functional modules. A functional module, according to one alternative embodiment, is embodied as an instruction sequence stored in the memory 615. The reader is advised that the term “minimally causes the processor” and variants thereof is intended to serve as an open-ended enumeration of functions performed by the processor 600 as it executes a particular functional module (i.e. instruction sequence). As such, an embodiment where a particular functional module causes the processor 600 to perform functions in addition to those defined in the appended claims is to be included in the scope of the claims appended hereto. It should also be noted that, according to one alternative embodiment, a portion of the memory 615 is used for storage of a known customer list 685. This example embodiment of a transaction terminal includes a customer list reception module 650, a customer identification module 660 and an incentive award module 665, each of which are stored in the memory 615. As depicted in the figure, alternative embodiments of the incentive award module include distinct modules for various award methods including at least one of an aggregate purchase tally module 670, an aggregate visit tally module 675 and a coupon module 680.

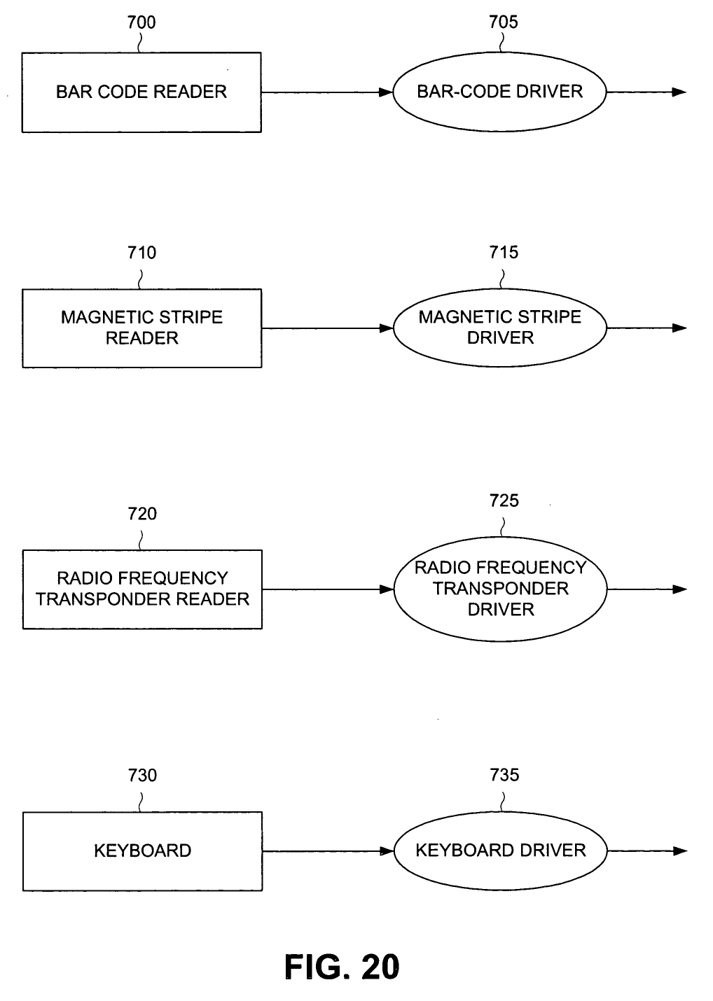

FIG. 20 is a composite of several data flow diagrams that depict alternative embodiments of a transaction customer identification unit. According to one alternative embodiment, the transaction customer identification unit comprises a bar-code reader 700. According to this alternative embodiment, the customer identification module 660 includes a bar-code driver 705 that, when executed by the processor 600, minimally causes the processor 600 to retrieve a transaction customer identifier from the bar-code reader 700 and make the transaction customer identifier available to the incentive award module 665 as it is executed by the processor 600.

According to another alternative embodiment, the transaction customer identification unit comprises a magnetic stripe reader 710. According to this alternative embodiment, the customer identification module 660 includes a magnetic stripe driver 715 that, when executed by the processor 600, minimally causes the processor 600 to retrieve a transaction customer identifier from the magnetic stripe reader 710 and make the transaction customer identifier available to the incentive award module 665 as it is executed by the processor 600.

According to another alternative embodiment, the transaction customer identification unit comprises a radio-frequency identification transponder reader 720. According to this alternative embodiment, the customer identification module 660 includes a radio-frequency identification transponder driver 725 that, when executed by the processor 600, minimally causes the processor 600 to retrieve a transaction customer identifier from the radio-frequency identification transponder reader 720 and make the transaction customer identifier available to the incentive award module 665 as it is executed by the processor 600.

According to another alternative embodiment, the transaction customer identification unit comprises a keyboard 730. According to this alternative embodiment, the customer identification module 660 includes a keyboard driver 735 that, when executed by the processor 600, minimally causes the processor 600 to retrieve a transaction customer identifier from the keyboard 730 and make the transaction customer identifier available to the incentive award module 665 as it is executed by the processor 600. It should be noted that the keyboard driver, according to this alternative embodiment, causes the processor 600 to assemble a transaction customer identifier from one or more keystrokes entered on the keyboard by a human user.

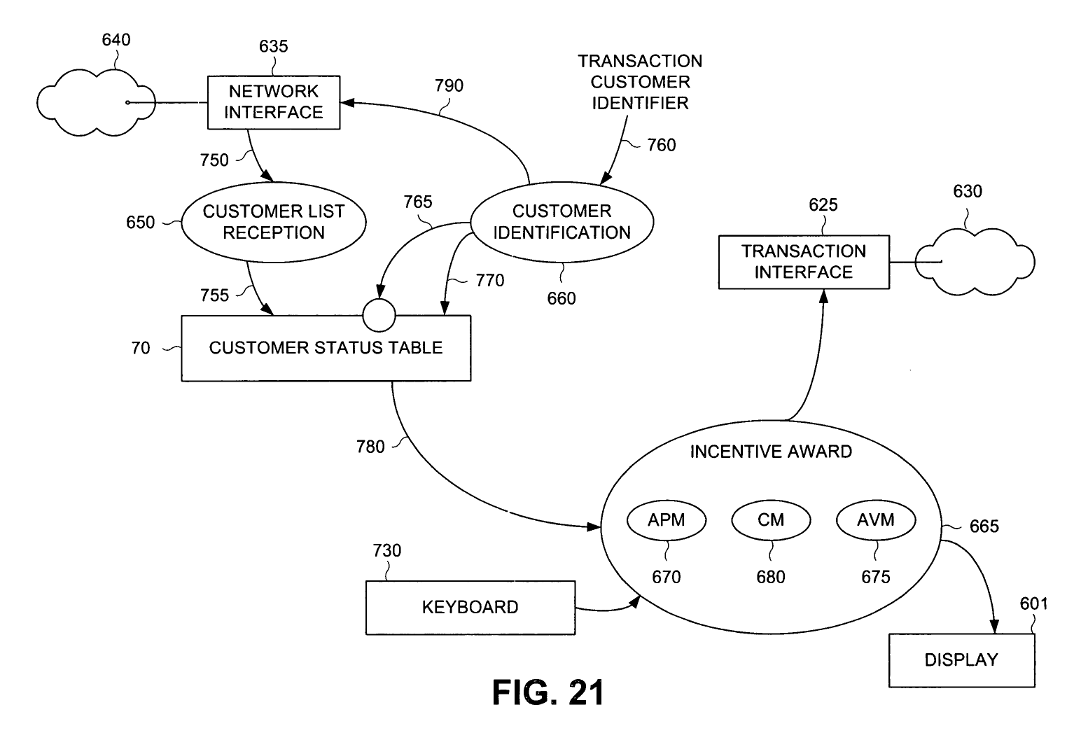

FIG. 21 is a data flow diagram that depicts the operation of one example embodiment of a transaction terminal. The customer list reception module 650, when executed by the processor 600, minimally causes the processor 600 to receive a list of known customer identifiers. The customer list reception module 650 minimally causes the processor 600 to interact with the network interface 635 in order to receive 750 a list of known customers from a wide area network 640. The customer list reception module 650 stores 755 the known customer list in a customer status table 70.

The processor 600 continues by executing the customer identification module 660. As heretofore described, the customer identification module 660 includes a driver for interacting with a particular hardware device (i.e. the transaction customer identification unit) from whence a transaction customer identifier 760 is received. When executed by the processor 600, the customer identification module 660 further minimally causes the processor 600 to use the transaction customer identifier as an index 765 into the customer status table 70. If a record can be selected from the customer status table 70 according to the transaction customer identifier 765 provided by the customer identification module 660, customer status information is made available 780 to the incentive award module 665. Incentive award module 665 further minimally causes the processor 600 to direct an incentive to the display 601 according to the information included in the known customer list, which is stored in the customer status table 70.

According to one alternative embodiment, the incentive award module 665 includes an aggregate purchase module (APM) 670. The aggregate purchase module 670, when executed by the processor 600, minimally causes the processor 600 to determine a customer-specific aggregate purchase tally according to a customer incentive status stored in the customer status table 70 and selected according to the transaction customer identifier 765. The aggregate purchase module 670 further minimally causes the processor to apply a customer privilege when the customer-specific purchase tally is greater than a pre-established amount. For example, one alternative embodiment of the aggregate purchase module 670 causes the processor to apply a customer privilege by directing a message to the display 601.

According to yet another alternative embodiment, the incentive award module 665 includes an aggregate visit module (AVM) 675. The aggregate visit module 675, when executed by the processor 600, minimally causes the processor 600 to determine a customer-specific aggregate visit tally according to a customer incentive status stored in the customer status table 70 and selected according to the transaction customer identifier 765. The aggregate visit module 675 further minimally causes the processor to apply a customer privilege when the customer-specific visit tally is greater than a pre-established amount. For example, one alternative embodiment of the aggregate visit module 675 causes the processor to apply a customer privilege by directing a message to the display 601.

According to yet another alternative embodiment, the incentive award module 665 includes a coupon module (CM) 680. The coupon module 680, when executed by the processor 600, minimally causes the processor 600 to determine the availability of a coupon according to a customer incentive status stored in the customer status table 70 and selected according to the transaction customer identifier 765. The coupon module 680 further minimally causes the processor to apply a customer privilege when a coupon is available and when coupon redemption is selected for the transaction. For example, one alternative embodiment of the coupon module 680 causes the processor 600 to display availability of a coupon on the display 601. The processor 600 then waits for an input from a human user that is indicative of a desire to apply the coupon to the transaction.

Once a transaction is complete, the incentive award module 665, when executed by the processor 600, further minimally causes the processor 600 to update the customer incentive status according to the particulars of the transaction. The incentive award module 665 further minimally causes the processor 600 to convey the particulars of the transaction and a corresponding customer identifier to the transaction interface 625. As a result, the particulars of a transaction are directed to the transaction network 630. A multi-entity customer relations management system can then receive the details of the transaction to update a customer status database.

According to one alternative embodiment, the customer identification module 660, when executed by the processor 600, further minimally causes the processor 600 to add 770 a customer transaction identifier to the list of known customer identifiers when the customer identifier is not found amongst the known customer identifiers stored in the customer status table 70. The customer identification module 660 further minimally causes the processor to direct 790 the new transaction customer identifier 760 to the network interface 635 thereby directing the new customer identifier to a wide area network 640. A multi-entity customer relations management system can then receive the new customer identifier and store the customer identifier in a known customer database or in a customer status table.

According to yet another alternative embodiment, the incentive award module 665 further minimally causes the processor to apply a bonus customer relations program when the processor 600 discovers that a customer has registered. This is accomplished when the incentive award module 665 minimally causes the processor 600 to select a record from the customer status table 70 according to the transaction customer identifier 765. Once a record is selected, registration information is retrieved 780 from the customer status table 70. A bonus customer relations program can include, but is not necessarily limited to providing a free good or service, e.g. a free sandwich.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

One feature of the claims appended hereto describes a transaction interface and a network interface. Although some embodiments will include two physical interfaces, each communicatively coupled with a separate communications network, other embodiments will include a single physical interface that enables communication of transactional information and other non-transactional information. The true scope and spirit of the claims intended hereto becomes apparent when the claims are read in the light of a functional transaction interface and a functional network interface. As such, an embodiment that includes only one physical interface that provides communications for both transaction and non-transaction information is to be included in the claims appended hereto.

What is claimed is:

1. A method for managing customer relations amongst a plurality of entities comprises:
managing a first customer relations program according to a customer identifier and a first entity identifier; and
managing a second customer relations program according to the customer identifier and a second entity identifier.

2. The method of claim 1 wherein managing a first customer relations program comprises:
defining an aggregate purchase level for an incentive for the first entity; and
maintaining an aggregate purchase tally according to a customer identifier and a first entity identifier.

3. The method of claim 1 wherein managing a first customer relations program comprises:
defining an aggregate visit level for an incentive for the first entity; and
maintaining an aggregate visit tally according to a customer identifier and a first entity identifier.

4. The method of claim 1 wherein managing a first customer relations program comprises associating a coupon with a customer identifier and a first entity identifier.

5. The method of claim 1 wherein associating a first customer relations program comprises:
receiving a transaction customer identifier for a customer transaction;
receiving an entity identifier for a first entity;
creating a tuple according to the transaction customer identifier and the entity identifier; and
associating a customer relations program with the tuple when the tuple is not yet associated with a customer relations program.

6. The method of claim 1 further comprising associating customer information with the customer identifier.

7. The method of claim 6 further comprising generating a promotional message to a customer according to the customer information.

8. The method of claim 6 further comprising directing a promotional message in the form of an electronic message to a customer according to the customer information.

9. The method of claim 6 further comprising conveying the customer information to an entity.

10. The method of claim 1 further comprising conveying customer status information associated with a customer identifier to an entity.

11. A system for managing customer relations amongst a plurality of entities comprising:
processor capable of executing an instruction sequence;
transaction interface capable of communicating with a transaction network;
memory; and
one or more instruction sequences stored in the memory including:
customer relations management module that, when executed by the processor, minimally causes the processor to:
manage a first customer relations program according to a customer identifier and a first entity identifier; and
manage a second customer relations program according to the customer identifier and a second entity identifier.

12. The system of claim 11 further comprising a network interface capable of communicating with a wide area network and wherein the customer relations manager module causes the processor to manage a first customer relations program by minimally causing the processor to:
accept an aggregate purchase level for an incentive by way of the network interface;
associate the accepted aggregate purchase level with a first entity identifier;
receive by means of the transaction interface a customer transaction message that includes the first entity identifier, a customer identifier and a purchase amount; and
maintain an aggregate purchase tally according to the first entity identifier, the customer identifier and the purchase amount.

13. The system of claim 11 wherein the customer relations manager module causes the processor to manage a first customer relations program by minimally causing the processor to:
accept an aggregate visit level for an incentive;
associate the accepted aggregate visit level with a first entity identifier;
receive by means of the transaction interface a customer transaction message that includes the first entity identifier and a customer identifier; and
maintain an aggregate visit tally according to the first entity identifier and the customer identifier.

14. The system of claim 11 wherein the customer relations manager module causes the processor to manage a first customer relations program by minimally causing the processor to:
accept a coupon definition; and
associate the coupon definition with a customer identifier and a first entity identifier.

15. The system of claim 11 wherein the customer relations manager module causes the processor to manage a first customer relations program by minimally causing the processor to:
receive by means of the transaction interface a customer transaction message that includes a first entity identifier and a customer identifier;
create a tuple according to the received first entity identifier and the customer identifier; and
associate a default customer relations program with the tuple when the tuple is not yet associated with a customer relations program.

16. The system of claim 11 further comprising a network interface capable of communicating with a wide area network and a customer information module that, when executed by the processor, minimally causes the processor to:
receive by means of the network interface customer information; and
associate the customer information with a customer identifier.

17. The system of claim 16 further comprising a print interface and a customer promotions dispatch module that, when executed by the processor, minimally causes the processor to:
generate a promotional message according to the customer information; and
convey the promotional message to the print interface.

18. The system of claim 16 further comprising a customer promotions dispatch module that, when executed by the processor, minimally causes the processor to convey by means of the network interface a promotional message to a customer an electronically deliverable message according to the customer information.

19. The system of claim 11 further comprising a network interface capable of communicating with a wide area network and a customer status dispatch module that, when executed by the processor, minimally causes the processor to convey to an entity by way of the network interface status information associated with a customer identifier.

20. A method for conducting a customer relations transaction comprising:
receiving a list of known customer identifiers from a multi-entity customer list;
receiving a transaction customer identifier; and
applying a customer relations program according to the transaction customer identifier when the transaction customer identifier is found in the list of known customer identifiers.

21. The method of claim 20 wherein receiving a transaction customer identifier comprises at least one of optically detecting a customer identifier, reading a magnetic stripe and determining a customer identifier according to a received electromagnetic signal.

22. The method of claim 20 wherein receiving a transaction customer identifier comprises:
receiving an arbitrary element of customer information; and
consulting the known list of customer identifiers using the arbitrary element of customer information in order to determine a customer identifier.

23. The method of claim 20 wherein applying a customer relations program comprises:
consulting the list of known customer identifiers according to the transaction customer identifier to determine customer incentive status; and
applying a customer incentive to a transaction according to the determined customer incentive status.

24. The method of claim 23 wherein applying a customer incentive comprises:
determining a customer-specific aggregate purchase tally according to the customer incentive status; and
applying a customer privilege when the customer-specific aggregate purchase tally is greater than a pre-established amount.

25. The method of claim 23 wherein applying a customer incentive comprises:
determining a customer-specific aggregate visit tally according to the customer incentive status; and
applying a customer privilege when the customer-specific aggregate visit tally is greater than a pre-established amount.

26. The method of claim 23 wherein applying a customer incentive comprises:
determining the availability of a coupon according to the customer incentive status; and
applying the coupon to the transaction when coupon redemption is selected.

27. The method of claim 23 further comprising updating the customer incentive status according to the transaction customer identifier and particulars of a transaction.

28. The method of claim 20 further comprising:
adding the transaction customer identifier to the list of known customer identifiers when the customer identifier is not found in the list of known customer identifiers; and
conveying the transaction customer identifier to a multi-entity customer relations management system.

29. The method of claim 20 further comprising applying a bonus customer relations program according to the transaction customer identifier when the transaction customer identifier is found in the list of known customer identifiers and the list of known customer identifiers indicates that the transaction customer identifier is registered.

30. A multi-entity aware customer transaction terminal comprising:
processor capable of executing an instruction sequence;
network interface capable of communicating with a wide area network;
transaction interface capable of communicating with a transaction network;
transaction customer identification unit;
display capable of presenting a customer incentive instruction;
memory capable of storing one or more instruction sequences; and
one or more instructions stored in the memory including:
customer list reception module that, when executed by the processor, minimally causes the processor to receive a list of known customer identifiers from a multi-entity customer list and store the list of known customers in the memory;
customer identification module that, when executed by the processor, minimally causes the processor to receive a transaction customer identifier by way of the transaction customer identification unit; and
incentive award module that, when executed by the processor, minimally causes the processor to direct to the display an incentive according to information included in the known customer list when the received transaction customer identifier is found in the known customer list.

31. The transaction terminal of claim 30 wherein the transaction customer identification unit comprises a bar-code reader and wherein the customer identification module includes a bar-code driver that, when executed by the processor, minimally causes the processor to retrieve a customer identifier from the bar-code reader.

32. The transaction terminal of claim 30 wherein the transaction customer identification unit comprises a magnetic stripe reader and wherein the customer identification module includes a magnetic stripe driver that, when executed by the processor, minimally causes the processor to retrieve a customer identifier from the magnetic stripe reader.

33. The transaction terminal of claim 30 wherein the transaction customer identification unit comprises a radio frequency identification transponder reader and wherein the customer identification module includes a frequency identification transponder driver that, when executed by the processor, minimally causes the processor to retrieve a customer identifier from the frequency identification transponder reader.

34. The transaction terminal of claim 30 wherein the transaction customer identification unit comprises a keyboard and wherein the customer identification module includes a keyboard driver that, when executed by the processor, minimally causes the processor to retrieve an arbitrary element of customer information and further wherein the customer identification module minimally causes the processor to determine a customer identifier by searching for a record in the received known customer list that includes the arbitrary element of customer information.

35. The transaction terminal of claim 30 wherein the incentive award module causes the processor to apply an incentive by minimally causing the processor to:
retrieve from the list of known customer identifiers stored in the memory a customer incentive status according to a transaction customer identifier; and
apply a customer incentive according to the customer incentive status.

36. The transaction terminal of claim 35 wherein the incentive award module includes an aggregate purchase tally module that, when executed by the processor, minimally causes the processor to apply a customer incentive by minimally causing the processor to:
determine a customer-specific aggregate purchase tally according to the customer incentive status; and
apply a customer privilege when the customer-specific purchase tally is greater than a pre-established amount.

37. The transaction terminal of claim 35 wherein the incentive award module includes an aggregate visit tally module that, when executed by the processor, minimally causes the processor to apply a customer incentive by minimally causing the processor to:
determine a customer-specific aggregate visit tally according to the customer incentive status; and
apply a customer privilege when the customer-specific visit tally is greater than a pre-established amount.

38. The transaction terminal of claim 35 wherein the incentive award module includes a coupon module that, when executed by the processor, minimally causes the processor to apply a customer incentive by minimally causing the processor to:
determine the availability of a coupon according to the customer incentive status; and
apply the coupon to a transaction when coupon redemption is selected.

39. The transaction terminal of claim 35 wherein the incentive award module further minimally causes the processor to:
convey the particulars of a transaction and a corresponding customer identifier to the transaction interface.

40. The transaction terminal of claim 30 wherein the customer identification module, when executed by the processor, further minimally causes the processor to:
add the customer transaction identifier to the list of known customer identifiers when the customer identifier is not found in said list of known customer identifiers; and
convey the transaction customer identifier to a multi-entity customer relations management system by way of the network interface.

41. The transaction terminal of claim 30 wherein the incentive award module further minimally causes the processor to apply a bonus customer relations program according to the transaction customer identifier when the transaction customer identifier is found in the list of known customer identifiers and the list of known customer identifiers indicates that the transaction customer identifier is registered.
